(19) United States
(12) Patent Application Publication
(10) Pub. No.: US 2009/0236955 A1
(43) Pub. Date: Sep. 24, 2009

(54) HANGING FILE BAR AND METHOD FOR USING SAME

(75) Inventor: Ronald D. Perrin, Huntington Beach, CA (US)

Correspondence Address: FULWIDER PATTON LLP, HOWARD HUGHES CENTER, 6060 CENTER DRIVE, TENTH FLOOR, LOS ANGELES, CA, 90045, US

(73) Assignee: REDI-TAG CORPORATION, Cypress, CA (US)

(21) Appl. No.: 12/052,445

(22) Filed: Mar. 20, 2008

(51) Int. Cl. B42F 15/00

(52) U.S. Cl. 312/184

(57) ABSTRACT

A bar for suspending a document between two parallel rails includes a substantially rectangular body having an upper edge, a lower edge, and a plurality of spaced apart holes centered about a midpoint of said body, said lower edge defining first and second integral hook members disposed at opposite ends of said body portion including a downwardly directed leg member on respective distal sides of the hook members.

### BACKGROUND OF THE INVENTION

A staple of any business or home office is the file cabinet and file drawer for storing important documents. File cabinets and file drawers typically include pairs of rails that extend from front to back at an upper portion of the drawer or cabinet and spaced twelve to fourteen inches apart, depending upon the size of the documents. Hanging file folders comprising a large sheet of material such as thin cardboard are folded in half to form a pocket or pouch for holding the documents in individual folders, and hung on the rails using opposed hook members on the upper surface of each half of the file folder. In this manner, many documents can be individually stored in separate hanging files for easy storage and retrieval.

One shortcoming of the above-described invention is that the hanging files themselves take up valuable space in the cabinet or drawer. Made of heavy cardboard, the file can take up more space than the document it is storing, reducing the amount of usable storage. Where there are many documents with only a few pages or less, the hanging files take up the majority of the space in the area intended for document storage. The hanging files, because they are made of folded material, tend to unfold and open up if the document is small, leading to a cluttered appearance of the file area. Moreover, documents with many pages do not fit well in the folders and can even protrude out of the folder. This also results in a cluttered file appearance as documents can protrude through the file folder at different heights. Conventional three ring binders present other challenges because they do not work well with the hanging folders. The cost of the file folders are also not insignificant and add to the expense of any office.

### SUMMARY OF THE INVENTION

The present invention comprises a simple, cost-effective solution to the shortcomings identified above in the form of a sturdy file bar for hanging documents in a standard file cabinet or drawer that eliminates the need for the hanging folder. The bar, which can be made of heavy-duty polypropylene or other plastic material, is preferably on the order of one sixteenth of an inch thick and includes integrally formed vertically oriented downwardly facing hook portions at respective ends of the bar to support the bar on rails of a file cabinet or drawer. The hook portions are preferably formed by a trapezoidal recess in the lower surface of the bar that creates an opening for receiving and retaining the rail therein while permitting lateral sliding of the bar along the rail. The recess is partially formed by a leg member at the distal end to prevent the bar from slipping off the rail. The bar preferably includes three apertures spaced approximately four and one quarter inches apart to coincide with three hole punched documents or three ring binders.

The above described invention eliminates the need for a hanging file folder, significantly increasing the space available in a typical file drawer or cabinet. For example, a magazine, catalog, or any bound material can be draped over hanging file bar and placed directly on the rails of the file cabinet without utilizing a hanging file folder. For loose paper documents, the bar can be used in conjunction with removable spine binders to hang directly on the file cabinet rails as well. The bars can also be used with various sized three ring binders to hang the binders in a file drawer or cabinet.

Other features and advantages of the invention will become apparent from the following detailed description, taken in conjunction with the accompanying drawings which illustrate, by way of example, the features of the invention

### BRIEF DESCRIPTION OF THE DRAWINGS

FIG. 1 is a plan form view of a first preferred embodiment of the present invention;

FIG. 2 is an elevated, perspective view of the first preferred embodiment;

FIG. 3 is another perspective view of the first preferred embodiment;

FIG. 4 is yet another perspective view of the first preferred embodiment;

FIG. 5 is still another perspective view of the first preferred embodiment; and

FIG. 6 is a second preferred embodiment with a plurality of holes for supporting a plastic comb or spiral bound document.

### DETAILED DESCRIPTION OF THE PREFERRED EMBODIMENTS

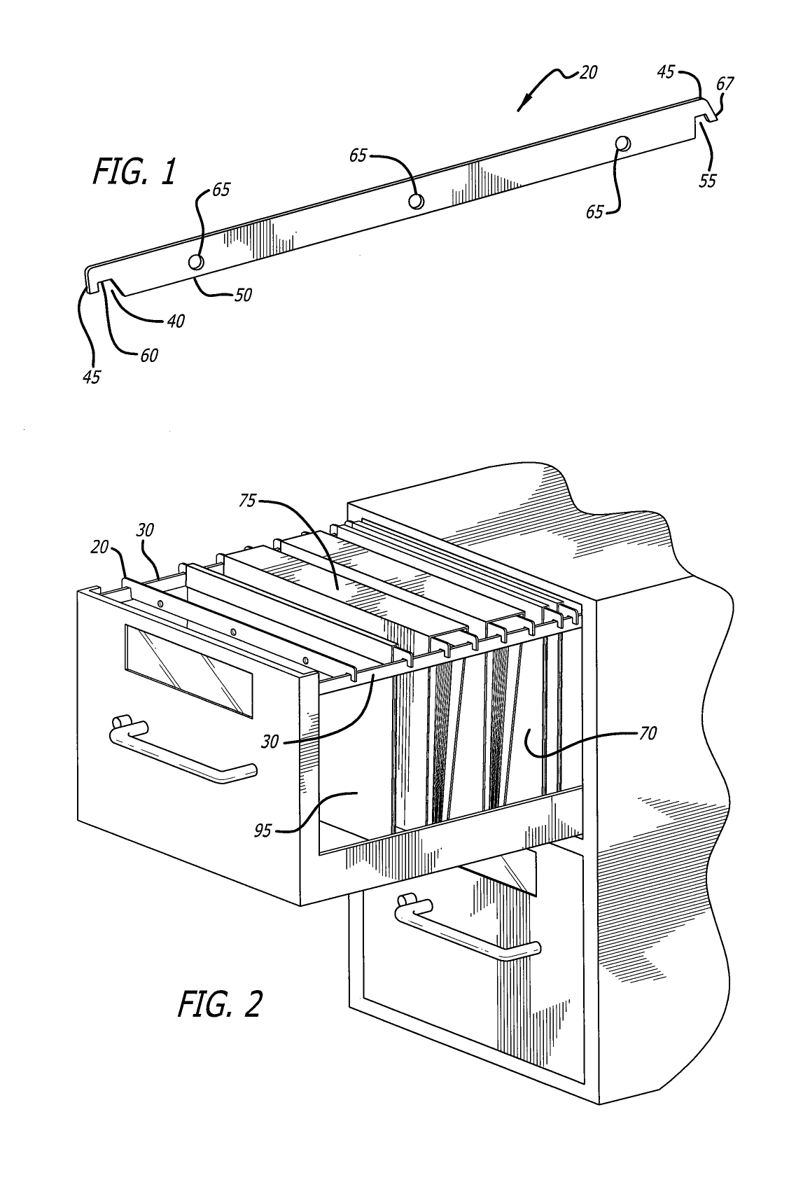

FIG. 1 of depicts a first preferred embodiment of the present invention comprising a sturdy but flexible bar 20 for hanging on a pair of spaced apart rails 30 used in file cabinets and file drawers. The length of the bar 20 is selected to hang from traditional file cabinet sizes such as twelve and one half inches for letter size documents to fifteen and one half inches for legal size documents. Letter size documents have a length of eleven inches, and the file cabinet rails 30 are typically spaced twelve inches apart to accommodate files for these documents. Because the bar 20 must be slightly larger that the distance between the rails to allow distal edges to overhang the rails and retain the bar thereon, the twelve and one half inch length provides for one quarter inch clearance on each side of the rails to allow for some play between the rail and the hook portion 40. Similarly, legal size documents are fourteen inches long and thus the rails 30 are traditionally spaced fifteen inches apart to accommodate the larger hanging file folders for these documents. A fifteen and one half inch bar 20 provides the quarter inch clearance on each side of the rails so that the bar can easily mount on each rail 30 with some tolerance.

The bar 20 is approximately three quarters of an inch in height and is substantially rectangular except for the hook portions 40 at the ends 45 of the bar 20. A preferred thickness is approximately one sixteenth of an inch, which provides the requisite stiffness to resist buckling but does not take up unnecessary space on the rails 30. For larger documents, two or more bars 20 can be used together if a single bar does not support the weight of the document. At each end, a hook member 40 is integrally formed by creating a void in the bar 20 along a lower edge 50 in the shape of a trapezoid. The trapezoidal recess 55 defines a mouth that is wider at the entrance than at the upper edge, which provides a guiding surface 60 as the bar 20 is lowered onto the rails 30. A lip or leg portion 67 extends downwardly adjacent the recess 55 on the distal side to capture the rail 30 and retain the rail in the recess. The bar 20 is preferably formed with two or three holes 65 centered along the length of the bar to coincide with documents having two or three punched holes in the margin.

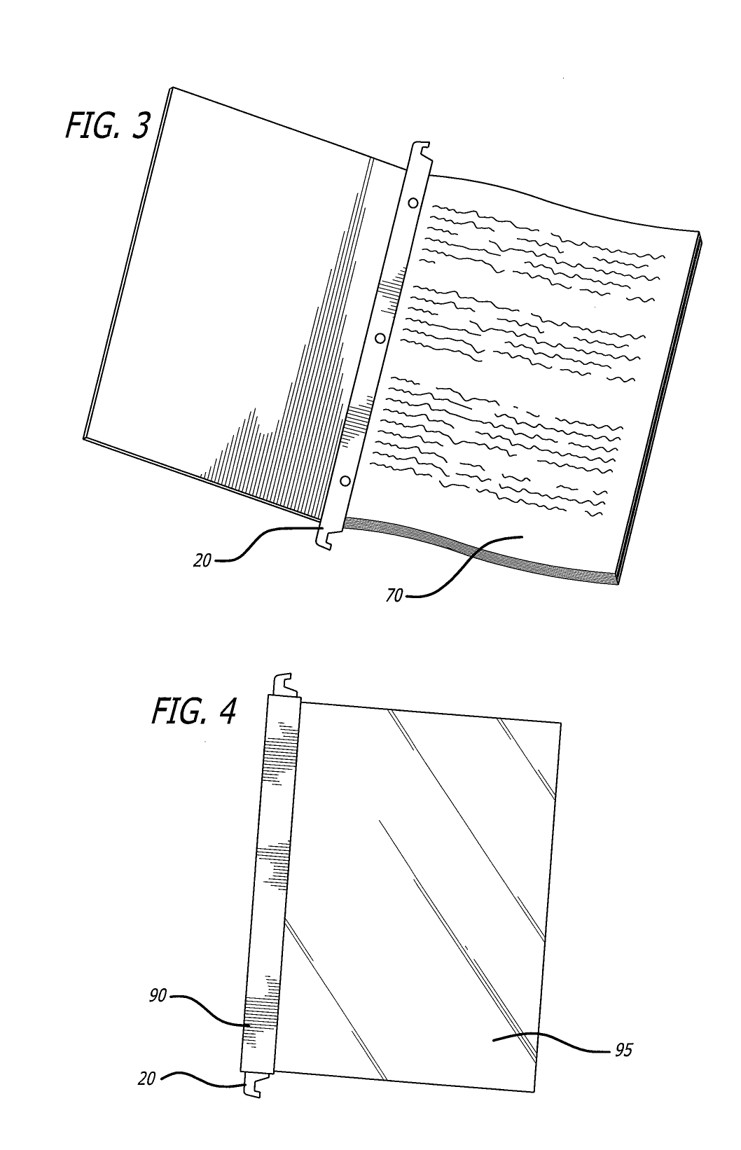

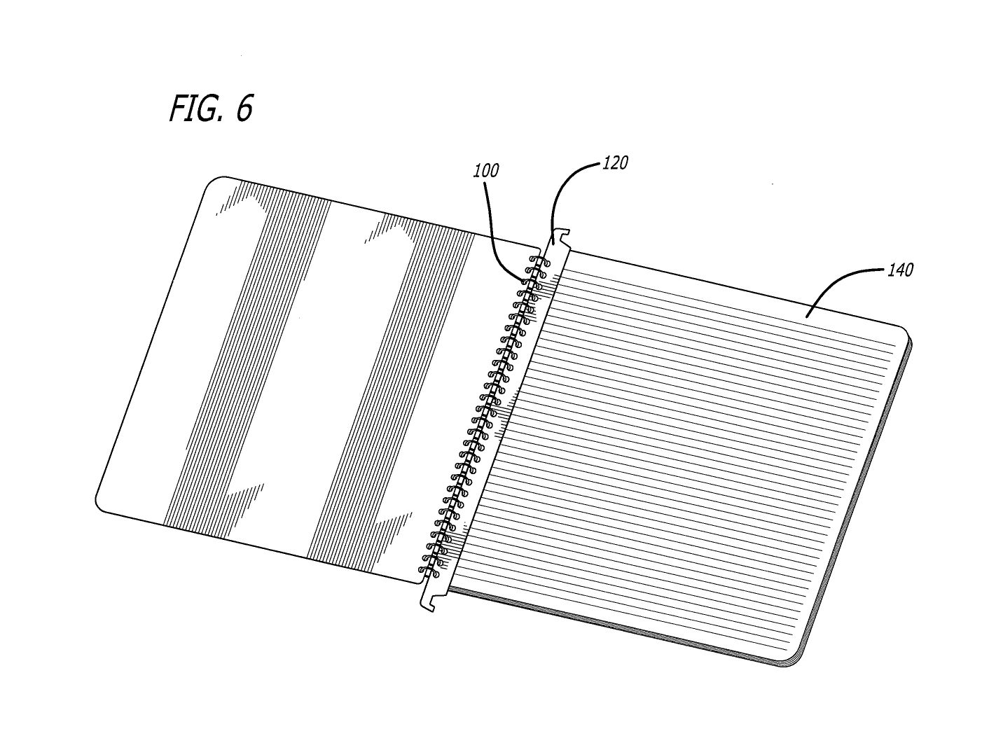

For bound documents 70 the bar 20 can be inserted into a middle section of the document as shown in FIG. 3 so that the document 70 is largely balanced on the bar with roughly equal weight distributed on both sides of the bar. This allows the document 70 to hang in the file cabinet or file drawer without space taken up by a file as shown in FIG. 2. For three ring binders 75 (FIG. 5), the rings 80 are opened and the exposed prongs are inserted into the holes 65 in the bar 20, and then the rings 80 of the binder 75 are closed to mount the binder on the bar. The bar 20 is then hung over the rails 30 of the file cabinet or file drawer as the binder is suspended between the rails 30. One bar 20 can be used on either side of the rings 80 to better balance the binder 75 on the rails 30 if necessary.

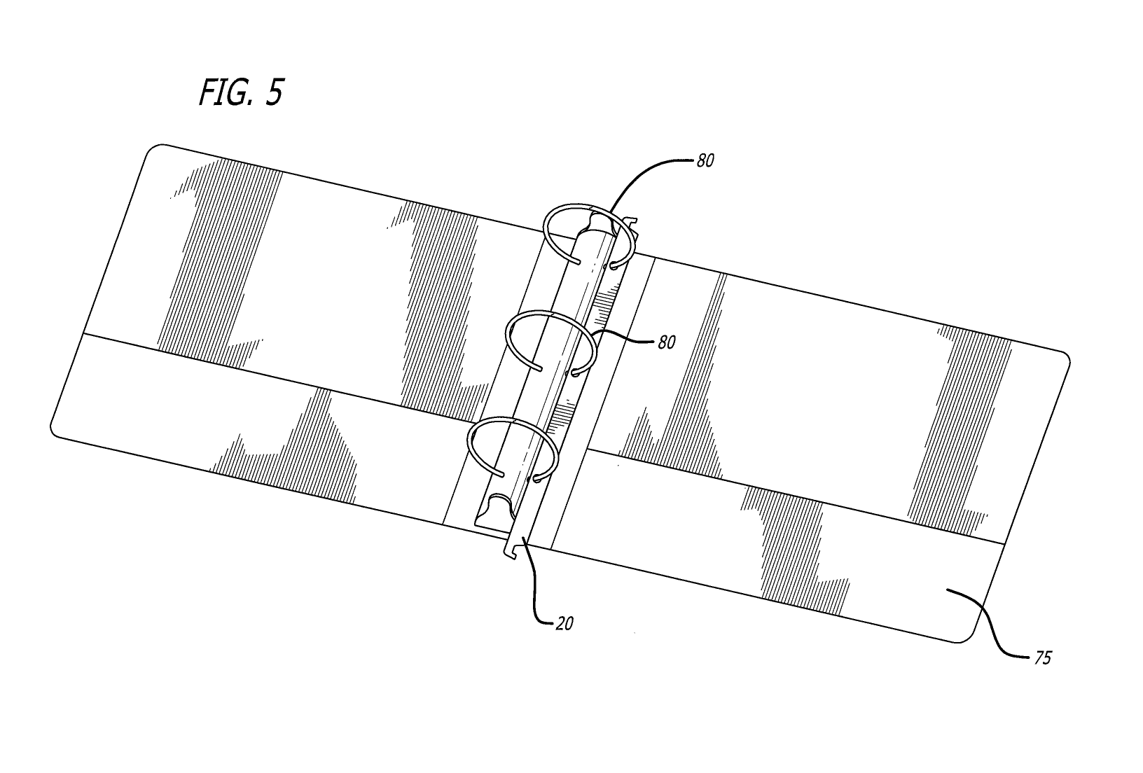

FIG. 4 shows how the bar 20 can be used with a document spine 90 to hang unbound documents 95. The document spine 90 is a commercially available 3-hole plastic snap binder that is placed over a document 95 and the bar 20. The spine 90 keeps the pages of the document 95 and the bar 20 together in a releasable compressed relationship. The bar 20 is oriented in the spine 90 such that the recesses 55 on the bar open toward document. With the spine 90 clamped on the bar 20 and document 95, the bar can be hung on the rails 30 and the spine 90 keeps the document 95 together so that it can be suspended between the rails and filed in the drawer or cabinet.

FIG. 6 shows a second preferred embodiment with a series of smaller holes 100 aligned along an edge of the bar 120 that can be used to support a plastic comb or coil bound notebook 140 or document. Here, the coil from the spiral notebook is passed through each hole 100 on the bar 120 until the notebook and the bar become joined together. The bar can then be placed on the rails as described above, suspending the notebook or document between the rails using only the present invention.

It should be understood that the description above is merely illustrative, and that those of ordinary skill in the art will readily discover modifications and alterations to the examples above. The scope of the present invention includes all such modifications and alterations and should not be limited in any manner to the specific embodiments described above or depicted in the drawings. Rather, the scope of the invention should be limited only by the words of the appended claims, using the common and ordinary meanings of the words except where expressly denoted herein.

I claim:

1. A bar for suspending a document between two parallel rails comprising:
a substantially rectangular body portion having an upper edge, a lower edge, and a plurality of spaced apart holes centered about a midpoint of said body portion, said lower edge defining first and second integral hook members disposed at opposite ends of said body portion including a downwardly directed leg member on respective distal sides of the hook members.

2. The bar of claim 1 wherein said holes are spaced four and one quarter inches apart.

3. The bar of claim 1 wherein the holes are approximately nine sixteenths of an inch in diameter.

4. The bar of claim 1 wherein the hook member is substantially trapezoidal shaped, and a lower edge of the hook members is larger than an upper edge.

5. The bar of claim 1 wherein the body portion is one sixteenth of an inch thick.

6. The bar of claim 1 wherein said body portion is made of polypropylene.

7. The bar of claim 1 further comprising indicia integrally formed on a first surface of said body portion.

8. The bar of claim 1 wherein a center of the first hook member and a center of the second hook members is spaced apart by a distance of at least twelve inches

9. The bar of claim 1 wherein said holes are aligned along an edge of the body portion and adapted to receive a single plastic comb or coil binder therein.

10. A method for hanging a document in a file cabinet having two support rails extending in a parallel configuration, comprising the steps of:
providing a bar having a body portion with an upper edge, a lower edge, and first and second integral hook members disposed at opposite ends of said body portion including a downwardly directed leg member on respective distal sides of the hook member, a center of the first hook member and a center of the second hook members spaced apart by a distance approximately equal to a distance between said parallel support rails;
placing the over the bar so as to balance the document on the bar; and
hanging the bar on the rails such that the hook members are engaged with the rails and the bar is extended therebetween, whereby the document is suspended between the rails and over the bar.

11. The method for hanging a document of claim 10 further comprising first binding the document along a first lateral edge to form a spine.

12. The method for hanging a document of claim 10 further comprising adding a second bar to support the document.

13. The method for hanging a document of claim 10 wherein said rails are approximately twelve inches apart.

14. The method for hanging a document of claim 10 wherein the body portion is one sixteenth of an inch thick.

15. The method for hanging a document of claim 10 wherein said body portion is made of polypropylene.

16. The method for hanging a document of claim 10 wherein the hook members are substantially trapezoidal shaped, and a lower edge of the hook members is larger than an upper edge.
